(19) United States
(12) Patent Application Publication
(10) Pub. No.: US 2019/0106303 A1
(43) Pub. Date: Apr. 11, 2019

(54) CRANE AND METHOD OF ASSEMBLING JIB

(71) Applicant: SUMITOMO HEAVY INDUSTRIES CONSTRUCTION CRANES CO., LTD., Tokyo (JP)

(72) Inventor: Hiroshi Kuninaga, Aichi (JP)

(21) Appl. No.: 16/150,669

(22) Filed: Oct. 3, 2018

(30) Foreign Application Priority Data
Oct. 6, 2017 (JP) 2017-196259

(51) Int. Cl. B66C 23/68; B66C 23/42

(52) U.S. Cl. CPC B66C 23/68; B66C 2700/0378; B66C 23/42

(57) ABSTRACT

A crane that performs a hanging operation by connecting a jib to a boom, includes: a plurality of jib divided bodies into which the jib is divided; a plurality of support rope divided bodies into which a support rope supporting the jib is divided, and which are respectively installed on the jib divided bodies in a step before assembling; a connection body which connects the support rope divided bodies to each other; and a fixed support member which detachably supports the support rope divided body and the connection body on the jib divided body, in which the fixed support member can hold the jib divided body connected to the boom, in a state of being hung by the connected support rope divided body.

### RELATED APPLICATION

Priority is claimed to Japanese Patent Application No. 2017-196259, filed Oct. 6, 2017, the entire content of which is incorporated herein by reference.

### BACKGROUND

### Technical Field

Certain embodiments of the present invention relate to a technique for assembling a jib of a crane in a work site.

### Description of Related Art

In the related art, a luffing-specification crane or a tower-specification crane is transported to a work site in a state where a jib is divided into a plurality of parts, and the divided jibs are assembled at a transport destination. As a method of assembling the jib, an extension type and an embracing type are known.

Further, as the related art, a mobile crane is disclosed in which a jib base end portion and a jib tip portion are connected to each other at a connection portion having a center-folding joining structure, so that a jib can be assembled and disassembled even at a narrow construction site (for example, the related art).

### SUMMARY

According to an embodiment of the present invention, there is provided a crane that performs a hanging operation by connecting a jib to a boom, including: a plurality of jib divided bodies into which the jib is divided; a plurality of support rope divided bodies into which a support rope supporting the jib is divided, and which are respectively installed on the jib divided bodies in a step before assembling; a connection body which connects the support rope divided bodies to each other; and a fixed support member which detachably supports the support rope divided body and the connection body on the jib divided body, in which the fixed support member can hold the jib divided body connected to the boom, in a state of being hung by the connected support rope divided body.

According to another embodiment of the present invention, there is provided a method of assembling a jib of a crane that performs a hanging operation by connecting a jib to a boom, the crane including a plurality of jib divided bodies into which the jib is divided, a plurality of support rope divided bodies into which a support rope supporting the jib is divided, and which are respectively installed on the jib divided bodies in a step before assembling, a connection body which connects the support rope divided bodies to each other, and a fixed support member which detachably supports the support rope divided body and the connection body on the jib divided body, the method including: making the connected jib divided body connected to the boom at one end be in a state of being lifted by the connected support rope divided body which has been connected; connecting the jib divided body to be connected subsequently and the connected jib divided body to each other in the lifted state; connecting the support rope divided body to be connected subsequently, which is disposed on the jib divided body to be connected, and the connected support rope divided body to each other by the connection body; and releasing the support of the connected jib divided body by the fixed support member.

### BRIEF DESCRIPTION OF THE DRAWINGS

FIG. 1 is a side view of a crane of an embodiment.

FIGS. 2A to 2E are diagrams describing processes of mounting a jib on a boom of the embodiment.

FIGS. 3A to 3D are diagrams describing processes of mounting the jib on the boom of the embodiment.

FIGS. 4A to 4C are diagrams describing processes of mounting the jib on the boom of the embodiment.

FIGS. 5A and 5B are diagrams describing processes of mounting the jib on the boom of the embodiment.

FIGS. 6A and 6B are diagrams describing processes of mounting the jib on the boom of the embodiment.

FIGS. 7A to 7C are diagrams showing an example of a connection mechanism of a jib connecting part and a pendant rope of the embodiment.

FIGS. 8A and 8B are diagrams describing processes of mounting the jib on the boom of the embodiment.

FIGS. 9A and 9B are diagrams describing processes of mounting the jib on the boom of the embodiment.

FIG. 10 is a diagram showing a state example when an abdominal part of the jib of the embodiment is connected.

FIG. 11 is a diagram describing a method of connecting the pendant rope of the embodiment.

FIG. 12 is a diagram showing an example of a state where a lock pin is released from the state of FIG. 11.

FIGS. 13A and 13B are diagrams describing processes of mounting the jib on the boom of the embodiment.

FIGS. 14A and 14B are diagrams describing processes of mounting the jib on the boom of the embodiment.

FIGS. 15A and 15B are diagrams describing processes of mounting the jib on the boom of the embodiment.

FIGS. 16A and 16B are diagrams describing processes of mounting the jib on the boom of the embodiment.

FIGS. 17A and 17B are diagrams describing processes of mounting the jib on the boom of the embodiment.

FIG. 18 is a diagram describing a process of mounting the jib on the boom of the embodiment.

FIG. 19 is a diagram showing an example of a list of an occupied length, an occupied width, and an occupied area for each assembling method.

FIGS. 20A to 20C are diagrams showing another an example of aspect of a mechanism for connecting the pendant rope.

FIGS. 21A to 21C are diagrams showing an example of the possibility of a combination of a boom length and a jib length in a case of using each assembling method.

FIGS. 22A to 22C are diagrams showing examples of states at the time of assembling with an extension type and an embracing type, and an example of an occupied length, an occupied width, and an occupied area for each assembling method.

### DETAILED DESCRIPTION

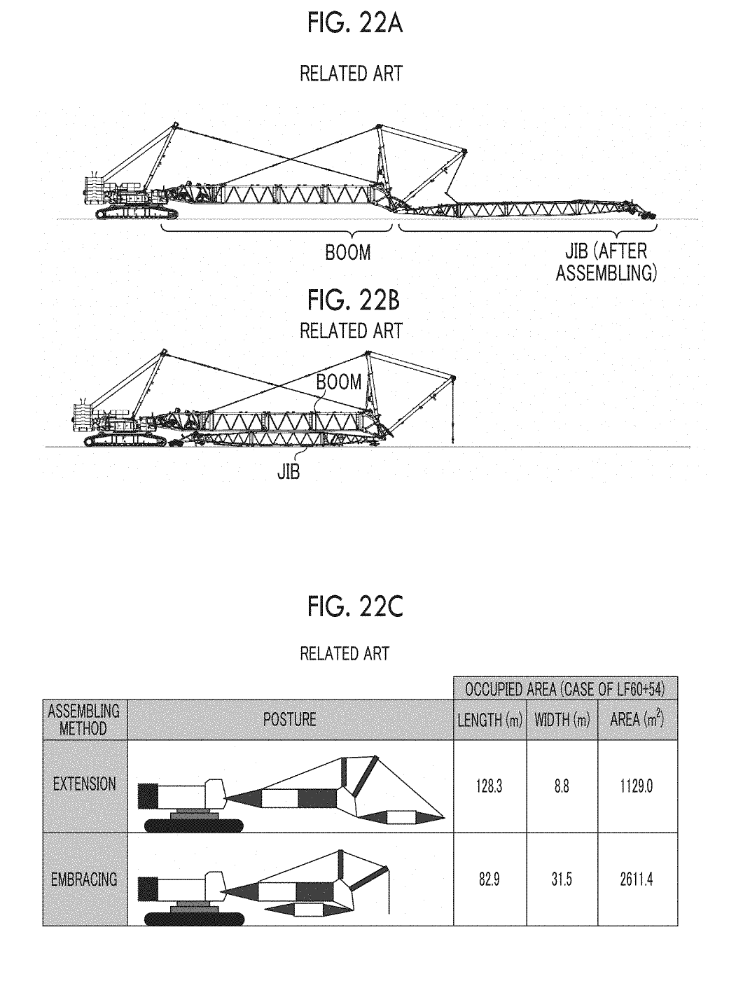

Here, FIG. 22A shows a state example in a case of assembling a jib by the extension type, and FIG. 22B shows a state example in a case of assembling a jib by the embracing type. Further, FIG. 22C illustrates a list of a length, a width, and an occupied area required for each of the extension type and the embracing type in a case where a boom length is set to be 60 m and a jib length is set to be 54 m.

In the case of the extension type, the boom and the jib are brought down on the ground, and the jib is assembled while extending the jib in one direction. In the case of the extension type, although assembling is easy, at least a work space corresponding to the added length of the total length of the boom in a longitudinal direction thereof and the total length of the jib in a longitudinal direction thereof is required.

In the case of the embracing type, since it is a method of assembling the jib with the jib folded back against the boom, an occupied length becomes shorter than that in the extension type. However, in a case where an assembling site is viewed from above, assembling work is not performed in a state where the boom and the jib are completely overlapped, and assembling is performed in a state where only the tip side of the boom and the base end side of the jib are overlapped with an angle formed with respect to each other. Therefore, an occupied width is required. Further, since assembling is performed in a state where the back surface side of the jib faces downward, work to turn upside down at the back surface side and the abdominal part side later is required, and thus time and effort are required correspondingly. Also in the method disclosed in the related art, assembling is performed in a state where the back surface side of the jib faces downward in some processes, and therefore, the same time and effort are required.

Further, in the case of the embracing type, in a case where it is difficult to transport the jib with the back surface side thereof facing downward, reversing work is performed at the site. However, in terms of safety or in order to smoothly perform the assembly work, usually, about two auxiliary cranes are required including the reversing work as well. However, in the work site, in many cases, it is difficult to secure a space for installing two auxiliary cranes. This problem also applies to the method disclosed in the related art.

In addition to the above, also when connecting each pendant rope, there is a case where situations that are disadvantageous for assembly and disassembly, such as the influence of the ground, occur, and therefore, there is also a case where time and effort are required to perform work of matching hole positions for connection with each other.

It is desirable to provide a technique that reduces an occupied area or the like when assembling a jib and facilitates jib assembling work.

According to the present invention, it is possible to provide a technique that reduces an occupied area when assembling the jib and facilitates the jib assembling work.

Hereinafter, aspects of an embodiment will be described with reference to the drawings.

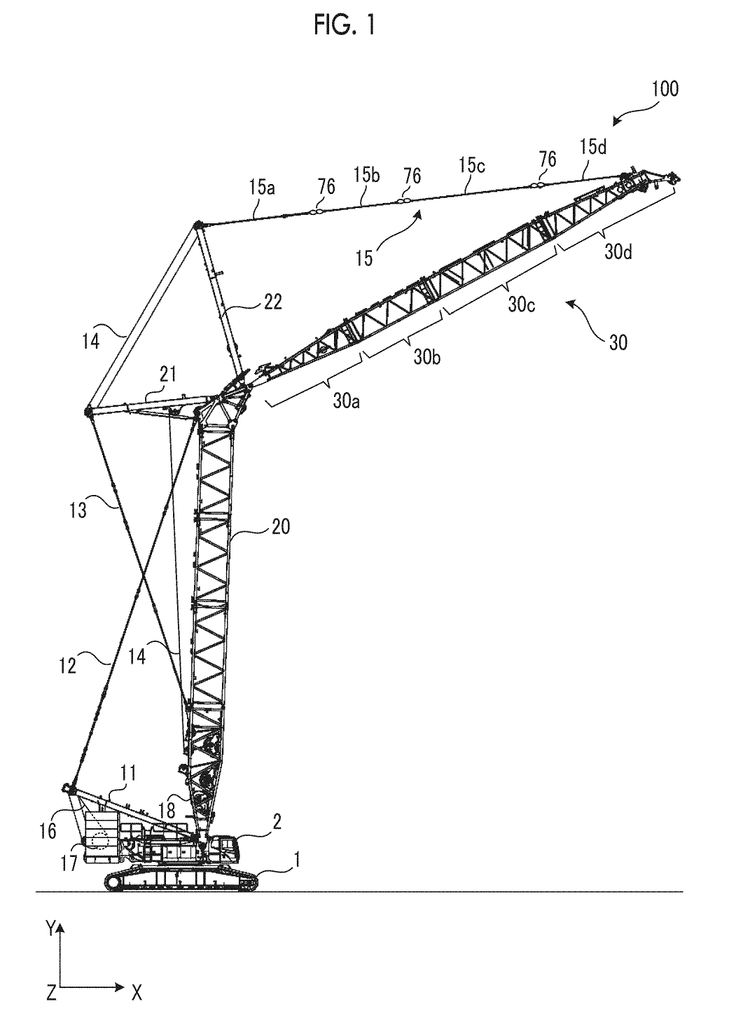

Fig.1 is a side view showing a schematic configuration of a crane of an embodiment. A crane 100 is a mobile crane which performs a hanging operation by connecting a jib to a boom, and has specifications including a boom hanging hook. The crane 100 has a lower traveling body 1 and an upper revolving body 2 which is rotatably mounted on an upper portion of the lower traveling body 1. The upper revolving body 2 is provided with a boom 20 which rotates up and down in an up-down direction, and a jib 30 which is rotatably supported on a tip portion of the boom 20. In the posture of the boom 20 or the jib 30 shown in FIG. 1, the surface on the side where each rope is installed (the surface on the left side of the boom 20 or the surface on the upper side of the jib 30) is referred to as a back surface. Further, the surface on the side where each rope is not installed (the surface opposite to the back surface, the surface on the right side of the boom 20, or the surface on the lower side of the jib 30) is referred to as an abdominal part side.

A mast 11 is rotatably supported on the upper revolving body 2, and a tip portion of the mast 11 and a tip portion of the boom 20 are connected to each other by a pendant rope 12. Further, a derricking rope 16 is wound between a derricking drum 17 and the tip portion of the mast 11. The derricking rope 16 is wound or unwound by the driving of the derricking drum 17, so that the mast 11 is rotated and the boom 20 is raised and lowered through the pendant rope 12.

A drum 18 is provided on the back surface side of the boom 20, and a wire 14 is wound around the drum 18. A front strut 22 is mounted on the base end side of the jib 30, and a pendant rope 15 which is a support rope for supporting the jib 30 with tension is connected between the front strut 22 and a tip portion of the jib 30.

A rear strut 21 is mounted on the top of the boom 20, and a pendant rope 13 is connected between the tip of the rear strut 21 and the boom 20. The wire 14 is wound or unwound by the driving of the drum 18, so that the front strut 22 is rotated and the jib 30 is raised and lowered through the pendant rope 15.

In this embodiment, the jib 30 has a configuration in which four jib dividedbodies; a lower jib 30a, a first intermediate jib 30b, a second intermediate jib 30c, and an upper jib 30d in order from the base end side which is connected to the boom 20, are connected in sequence. A wire rope is extended from the tip side of the upper jib 30d, and a hook is hung on a lower end portion of the wire rope.

In this embodiment, the jib 30 is transported with it divided into four parts, and the lower jib 30a, the first intermediate jib 30b, the second intermediate jib 30c, and the upper jib 30d are sequentially joined and assembled in this order at a work site. Further, the pendant rope 15 is also configured of four support rope divided bodies; pendant ropes 15a to 15d, and is transported to the work site in a state where the pendant ropes 15a to 15d are respectively installed on the back surface sides of the respective jibs 30a, 30b, 30c, and 30d. The divided pendant ropes 15a to 15d are connected by rope connecting members 76 (connection bodies) and finally become one pendant rope 15.

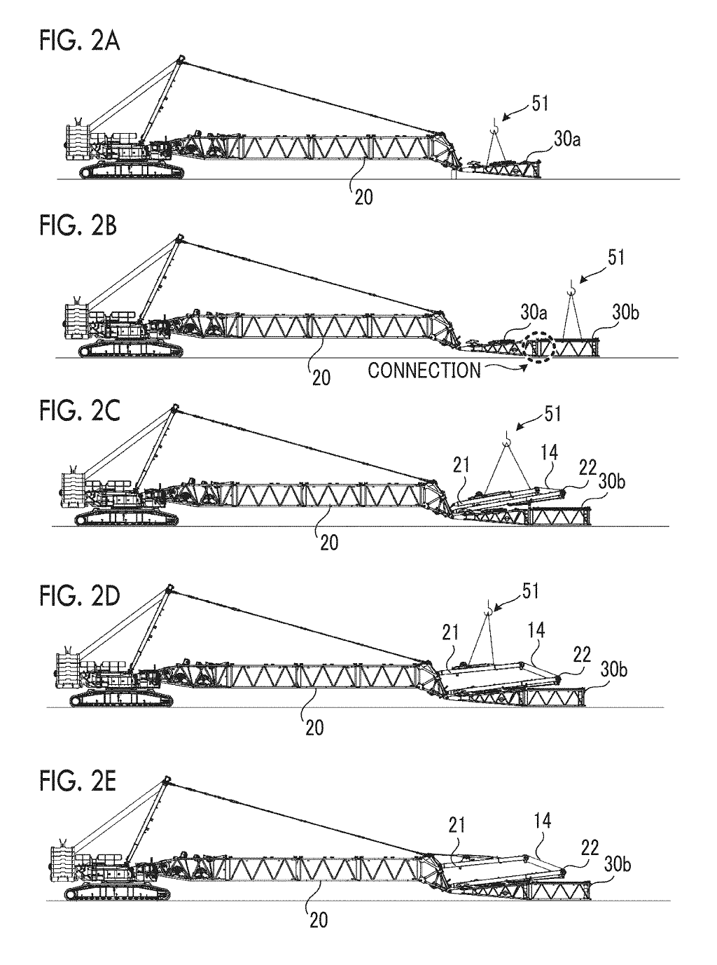

Subsequently, a jib assembling method at the work site in this embodiment will be described with reference to FIGS. 2A to 2E and the subsequent drawings. Each drawing of FIGS. 2A to 2E and the subsequent drawings shows each process of the assembling method in order.

First, the boom 20 is kept in a brought-down state, the lower jib 30a is hung by an auxiliary crane 51 and brought close to the boom 20, and the base end of the lower jib 30a is mounted on the tip of the boom 20 (FIG. 2A). Next, the first intermediate jib 30b, which is a jib for addition, is hung by the auxiliary crane 51 and mounted on the tip side of the lower jib 30a by using a connection pin (FIG. 2B).

A component part (assembly) which includes the front strut 22 and the rear strut 21 is hung by the auxiliary crane 51 and mounted on the boom 20 (FIG. 2C). Then, the rear strut 21 is separated and lifted from the front strut 22, hung by the auxiliary crane 51, and mounted on the boom 20 (FIG. 2D). Then, a backstop cylinder of the rear strut 21 is extended and a raising mechanism for the rear strut 21 is mounted thereon (FIG. 2E). In this way, the hanging assistance of the auxiliary crane 51 is not needed, and therefore, the auxiliary crane 51 and a sling are removed.

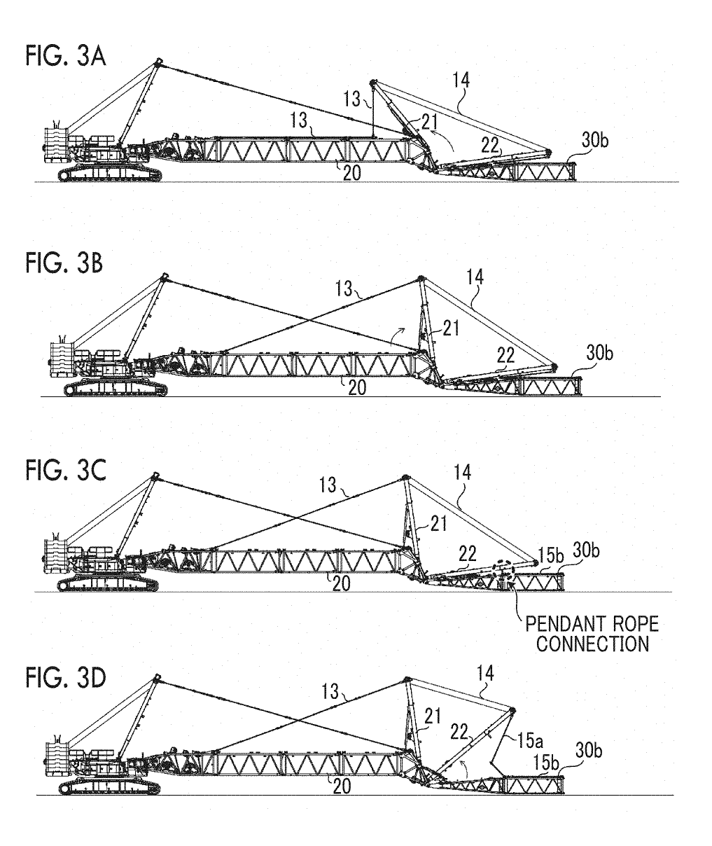

Next, the rear strut 21 is tilted rearward by operating the backstop cylinder of the rear strut 21 by using an external hydraulic source, and the pendant rope 13 supporting the rear strut 21 is mounted on the tip of the rear strut 21 (FIG. 3A). The pendant rope 13 is already disposed on the back surface side of the boom 20.

The rear strut 21 is raised by extending the backstop cylinder of the rear strut 21 by using the external hydraulic source, so that the pendant rope 13 is tensed up (FIG. 3B) . Then, the pendant rope 15b installed on the back surface of the first intermediate jib 30b and the pendant rope 15a on the front strut 22 side are connected to each other (FIG. 3C). With respect to this connection, it is also possible to divert the connecting method of the pendant ropes 15b and 15c, which will be described later. Next, the front strut 22 is raised and a jib backstop is mounted thereto (FIG. 3D). The procedure so far is the same as an extension type jib assembling method.

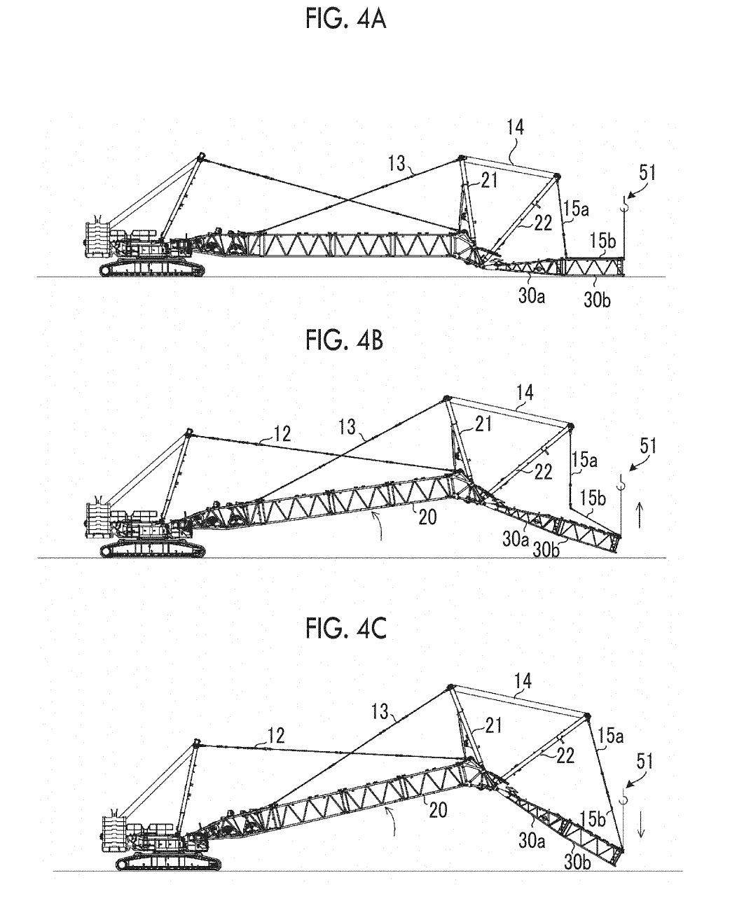

Subsequently, the description of the assembling method of this embodiment will be continued. A sling is connected to the tip of the first intermediate jib 30b and the first intermediate jib 30b is hung by the auxiliary crane 51 (FIG. 4A). At this timing, a cure is performed for awhile through electric wiring. Then, the boom 20 is raised and the first intermediate jib 30b is lifted by the auxiliary crane 51 (FIG. 4B). Further, while the boom 20 is raised, at the same time, the auxiliary crane 51 performs lowering, so that the pendant ropes 15a and 15b are stretched (FIG. 4C).

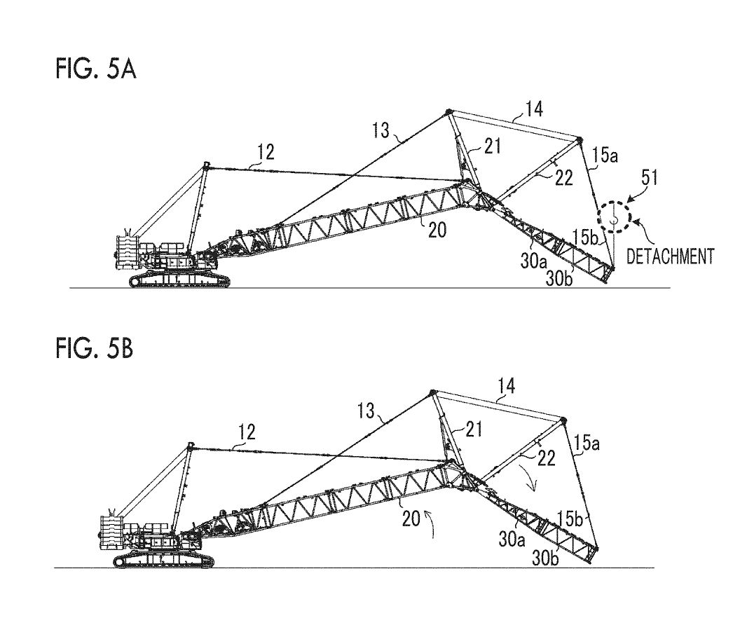

Then, the sling supporting the tip side of the first intermediate jib 30b is detached, so that the support by the auxiliary crane 51 is released (FIG. 5A). In this way, a state where the jibs 30a and 30b are supported by themselves by only the pendant ropes 15a and 15b is created. In this state, the tip of the pendant rope 15b is supported by a fixed support member 70 (described later) on the tip side of the first intermediate jib 30b. That is, the fixed support member 70 on the tip side of the first intermediate jib 30b holds the lower jib 30a and the first intermediate jib 30b which have been connected to the boom 20, in a state of being hung by the connected pendant ropes 15a and 15b. In this state, the jibs 30a and 30b are lowered while raising the boom 20, thereby making the front strut 22 and the boom 20 parallel to each other (FIG. 5B).

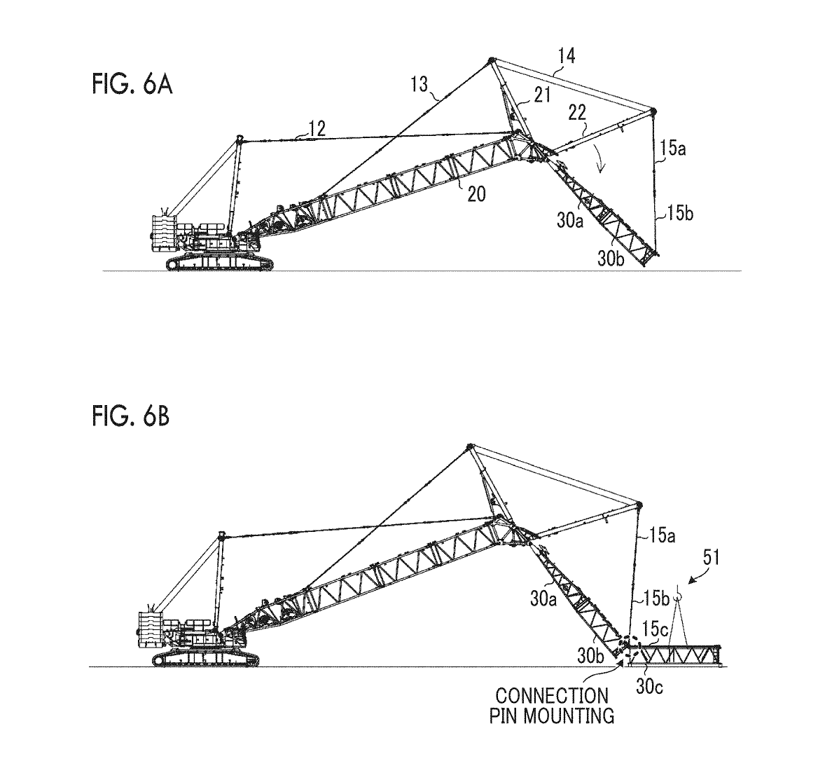

Further, the tip sides of the jibs 30a and 30b are lowered until the rear strut 21 becomes parallel to the jibs 30a and 30b (FIG. 6A). Then, the second intermediate jib 30c, which is a jib to be added next, is hung by the auxiliary crane 51 and moved to the vicinity of the first intermediate jib 30b. Then, the back surface sides of the first intermediate jib 30b and the second intermediate jib 30c are connected to each other with a connection pin (FIG. 6B).

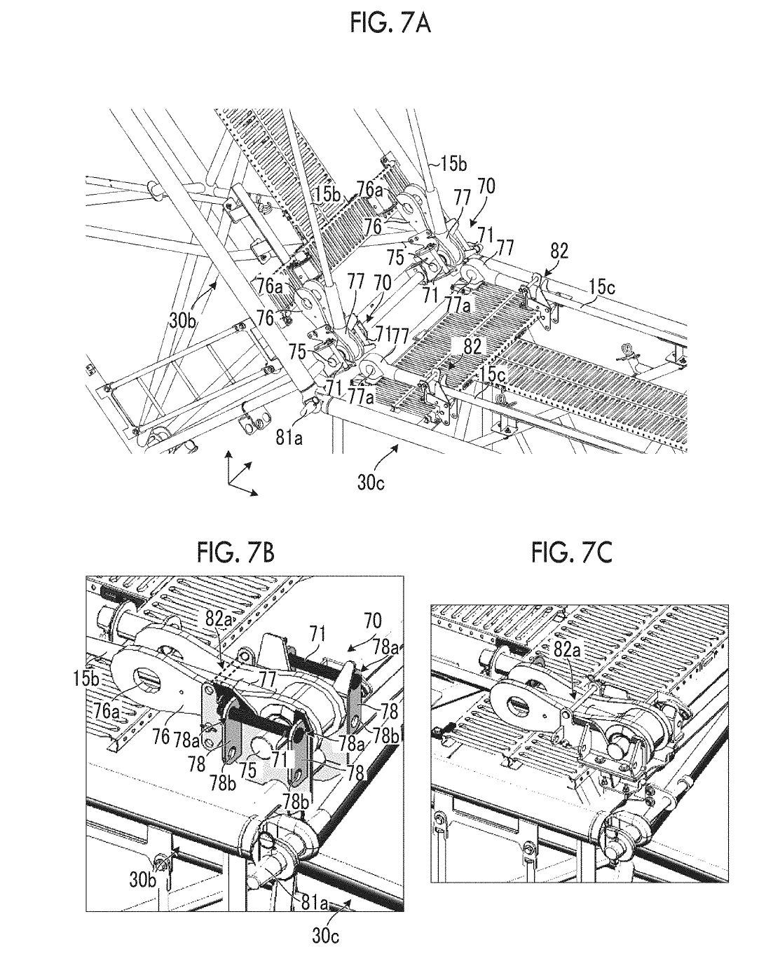

Here, an example of a connection part which connects both the first intermediate jib 30b and the second intermediate jib 30c and a mechanism for connecting the pendant ropes 15b and 15c will be described with reference to FIGS. 7A to 7C. Here, the jibs 30b and 30c and the pendant ropes 15b and 15c are referred to. However, this is also applied to other jibs or other pendant ropes. FIG. 7A is an example of the state of the vicinity of a site connecting the first intermediate jib 30b and the second intermediate jib 30c when the processes up to the process described in FIG. 6B have been performed. Further, FIG. 7B is an enlarged view of the mechanism for connecting the pendant rope 15b on the first intermediate jib 30b side and the pendant rope 15c on the second intermediate jib 30c side. FIG. 7C is a diagram showing a mechanism for connecting pendant ropes of the related art and is a diagram for comparison with the aspect of this embodiment.

First, the connection mechanism of the pendant rope 15 will be described. As described above, the pendant ropes 15a to 15d corresponding to the respective jibs are respectively disposed on the back surface sides of the respective jibs 30a to 30d. Here, paying attention to the pendant rope 15b of the first intermediate jib 30b, a rope connection pin 75 protruding in a vertical direction (a Z-axis direction) from an extension direction of the pendant rope 15 is formed at an end portion 77 (on the tip side) of the pendant rope 15b. The pendant rope 15b is rotatable with the rope connection pin 75 as a rotating shaft.

The fixed support member 70 fixed to a main body portion of the first intermediate jib 30b is a member which detachably supports the pendant rope 15b and the rope connecting member 76 on the first intermediate jib 30b. Referring to FIG. 7B, support plates 78 configuring a part of the fixed support member 70 are disposed at the front and rear in a longitudinal direction of the first intermediate jib 30b so as to face each other with the rope connection pin 75 interposed therebetween. Further, the support plates 78 in which a pair of front and back support plates 78 forms one set are disposed on the right and left (in a width direction of the first intermediate jib 30b) so as to clamp the end portion 77 of the pendant rope 15b and the rope connecting member 76 on both sides. In the pair of front and back support plates 78, a pair of first hole portions 78a is formed at positions facing each other, and a pair of second hole portions 78b is formed at positions facing each other below the first hole portions 78a. In the posture shown in FIG. 7B, the first hole portion 78a is positioned above the rope connection pin 75, and the second hole portion 78b is positioned below the rope connection pin 75.

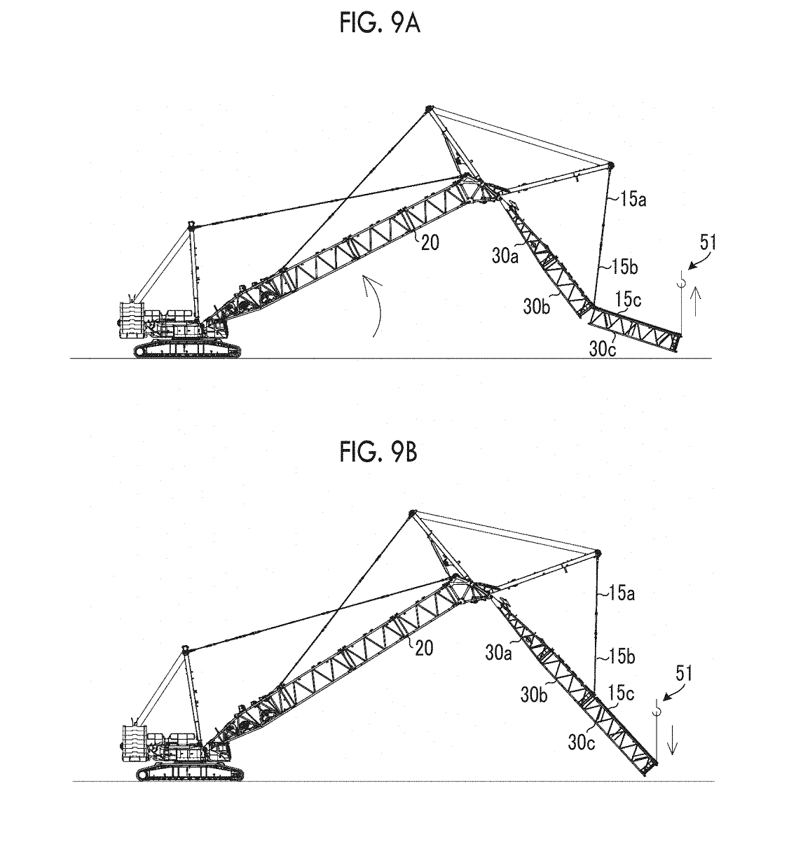

A lock pin 71 is inserted so as to penetrate the pair of first hole portions 78a formed to face each other in the front and back. That is, the lock pin 71 is provided with respect to each of the right and left support plates 78, and in the posture shown in FIG. 7B, the lock pin 71 is installed over a position above the rope connection pin 75. With the configuration in which the lock pin 71 is located above the rope connection pin 75, if the pendant rope 15b is pulled upward, the lock pin 71 and the rope connection pin 75 are brought into contact with each other and engaged with each other, and it is possible to maintain the posture of hanging the jibs 30a and 30b at the tip portion of the first intermediate jib 30b, as shown in FIG. 5B or FIGS. 9A and 9B (described later) or the like. In the assembling process of the related art, the process of forming the hanging posture at the pendant rope 15b shown in FIG. 5B or FIGS. 9A and 9B (described later) or the like is not included. Accordingly, in the pendant rope connection mechanism of the related art shown in FIG. 7C, there is no lock pin or hole portion for inserting the lock pin.

In this manner, the fixed support member 70 which includes the lock pin 71 or the support plate 78 in the configuration thereof is configured to support the pendant rope 15b and the rope connection pin 75 which serves as the rotating shaft of the rope connecting member 76. Further, with this configuration, it becomes possible to hang the jibs 30a and 30b with the pendant ropes 15a and 15b. In addition, in the fixed support member 70, it also becomes possible to easily open and separate the pendant rope 15b and the rope connecting member 76 from the first intermediate jib 30b by pulling out the lock pin 71 from the pair of first hole portions 78a.

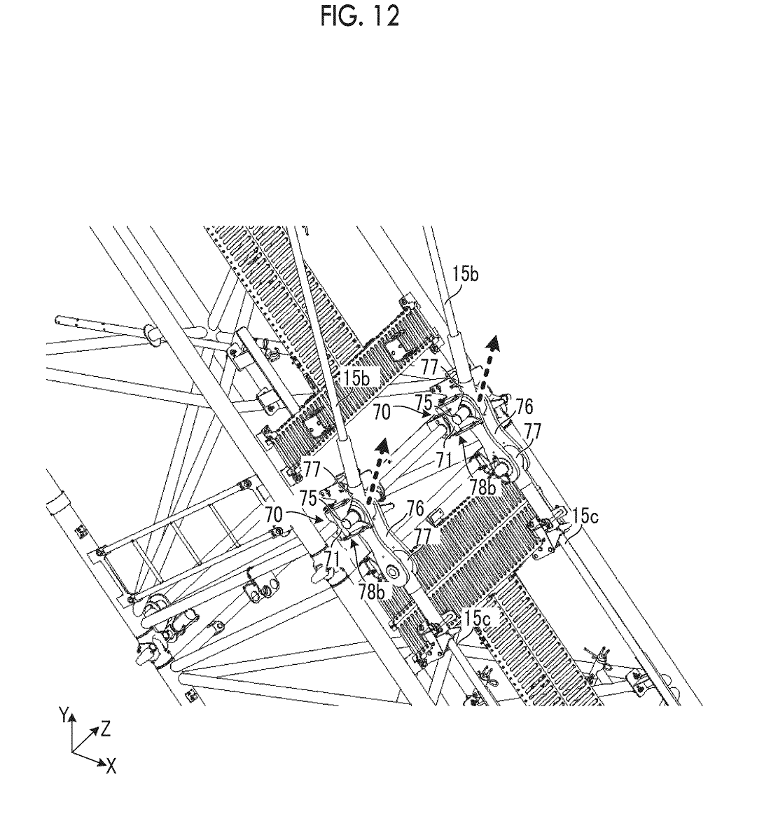

The rope connecting member 76 is a member which clams the end portion 77 of the pendant rope 15b on both sides and rotates with the rope connection pin 75 as a rotating shaft, separately from the pendant rope 15b. One end portion of the rope connecting member 76 has the rope connection pin 75 in this manner. However, a hole portion 76a is formed at the other end portion of the rope connecting member 76. Although details will be described later using FIG. 11, in a subsequent process, one through-hole is formed by overlapping the hole portion 76a with the hole portion 77a on the pendant rope 15c side by rotating the rope connecting member 76, and a connection pin is inserted into the through-hole. In this way, the pendant rope 15b and the pendant rope 15c are connected to each other.

On the other hand, a deviation prevention mechanism 82 is fixed to the main body of the second intermediate jib 30c. The deviation prevention mechanism 82 is a suppressing member for suppressing a deviation on the end portion side of the pendant rope 15c by clamping the vicinity of the end portion 77 (on the base end side) of the pendant rope 15c. In this way, the movement of the end portion 77 is restricted to some extent, and therefore, the alignment of the hole portion 76a and the hole portion 77a becomes easy.

In the process described with reference to FIG. 6B, a connection pin 81a shown in FIG. 7A is inserted, whereby the back surface sides of the first intermediate jib 30b and the second intermediate jib 30c are connected to each other . Further, the second intermediate jib 30c is rotated with respect to the first intermediate jib 30b with the connection pin 81a as a rotating shaft.

At the end of the description of FIGS. 7A to 7C, the mechanism of the related art of FIG. 7C will be supplementarily described. A pin 82a shown in FIG. 7C is a restricting member for preventing the pendant rope from being separated from the jib during transportation and for restricting the rotation of the rope connecting member 76. Also in the mechanism of this embodiment, the pendant rope 15b and the rope connecting member 76 can be fixed to the first intermediate jib 30b by inserting the pin 82a into the broken line position shown in FIG. 7B. The pin 82a does not have strength which can withstand the hanging posture of the jib by the pendant rope 15b shown in FIGS. 9A and 9B (described later). That is, the pin 82a cannot hold the jib divided body connected to the boom, in a state of being hung by the connected support rope divided body.

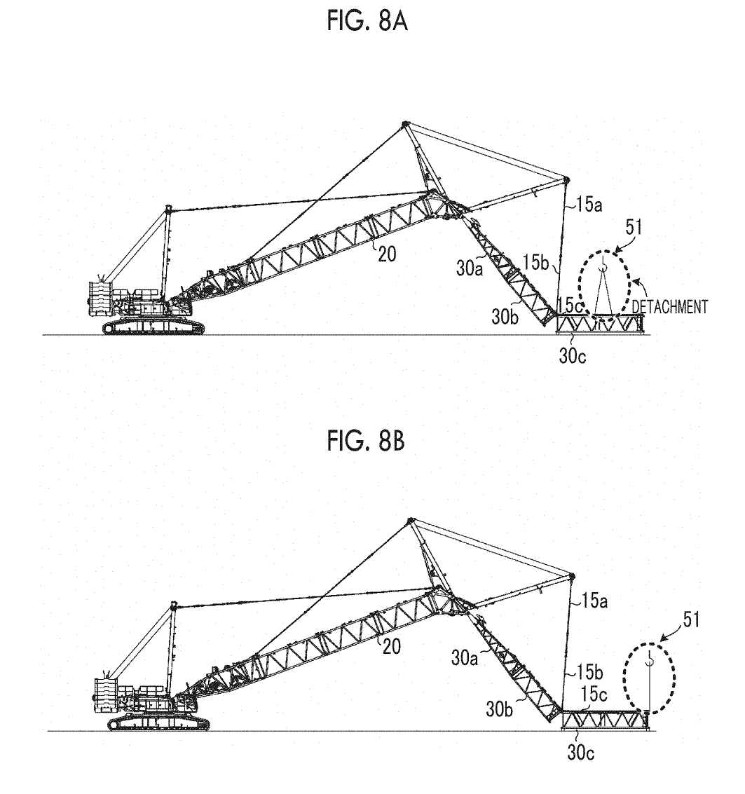

Subsequently, the description of the assembling processes will be continued with reference to FIGS. 8A and 8B, and 9A and 9B. The second intermediate jib 30c, which is a jib for addition, is placed on the ground and the sling of the auxiliary crane 51 is detached therefrom (FIG. 8A). Then, the detached sling is in turn connected to the tip side of the second intermediate jib 30c and is lifted by the auxiliary crane 51 (FIG. 8B).

The boom 20 is raised and the tip side of the second intermediate jib 30c is lifted by the auxiliary crane 51 (FIG. 9A). The pendant ropes 15a and 15b are also pulled upward in conjunction with the rising of the boom 20, and thus the rope connection pin 75 which is a protrusion portion on the pendant rope 15b side shown in FIGS. 7A and 7B is brought into contact with the lock pin 71 on the fixed support member 70 side. Then, if the pendant ropes 15a and 15b are further pulled upward, the rope connection pin 75 is also lifted and moved upward. Then, in conjunction with this, the lock pin 71 which is in contact with the rope connection pin 75 and the fixed support member 70 which supports the lock pin 71 also move upward, and the tip side of the first intermediate jib 30b is also lifted through these. Further, the end portion on the back surface side of the first intermediate jib 30b and the end portion on the back surface side of the second intermediate jib 30c are coupled to each other by the connection pin 81a, and therefore, if the first intermediate jib 30b is lifted, the second intermediate jib 30c is also lifted continuously.

With respect to the posture shown in FIG. 9A, the auxiliary crane 51 performs lowering downward while further raising the boom 20, whereby the first intermediate jib 30b and the second intermediate jib 30c are aligned with each other. In the state of being aligned in this manner, both the end portion on the abdominal part side of the first intermediate jib 30b and the end portion on the abdominal part side of the second intermediate jib 30c are also brought into contact with each other (FIG. 9B).

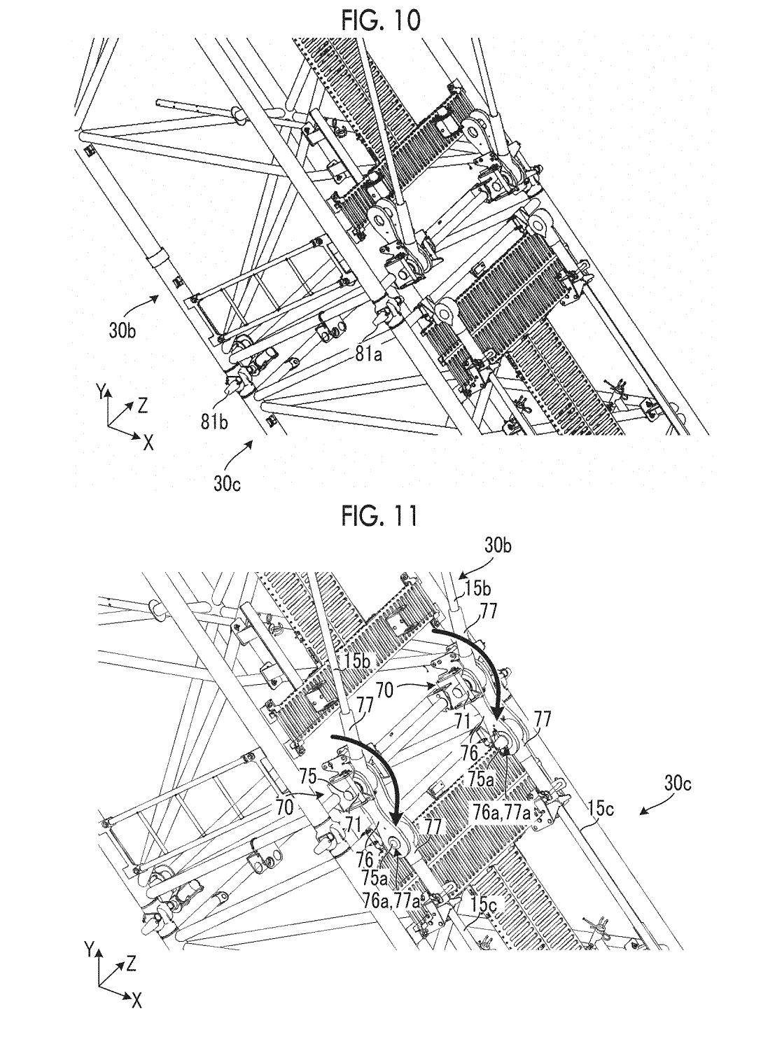

After the state shown in FIG. 9B is created, the abdominal part sides in contact with each other are connected to each other with a connection pin. That is, as shown in FIG. 10, a connection pin 81b is mounted in hole portions on the abdominal part sides of the first intermediate jib 30b and the second intermediate jib 30c. In this manner, the connection pin 81a is mounted on the back surface sides of the first intermediate jib 30b and the second intermediate jib 30c and the connection pin 81b is mounted on the abdominal part sides of the first intermediate jib 30b and the second intermediate jib 30c, whereby the first intermediate jib 30b and the second intermediate jib 30c are in a fixed state. In this way, the lower jib 30a, the first intermediate jib 30b, and the second intermediate jib 30c are integrated.

After the connection pin 81b on the abdominal part side is mounted, the pendant rope 15b on the first intermediate jib 30b side and the pendant rope 15c on the second intermediate jib 30c side are connected to each other. This state is shown in FIG. 11. The rope connecting member 76 rotates in the direction of an arrow around the rope connection pin 75. With this rotation, the hole portion 76a of the rope connecting member 76 and the hole portion 77a on the pendant rope 15c side overlap each other at the same position, and one through-hole is formed by these hole portions 76a and 77a. A connection pin 75a is inserted into this through-hole. In this way, the pendant rope 15b and the pendant rope 15c are connected to each other through the rope connecting member 76.

After the pendant ropes 15b and 15c are connected to each other, the lock pin 71 is pulled out and removed from the first hole portion 78a. Then, in order to prevent loss of the lock pin 71, the lock pin 71 is inserted into the second hole portion 78b. This state is shown in FIG. 12. If the lock pin 71 is removed and on the other hand, the restraint by the deviation prevention mechanism 82 is released (specifically, if the pin that holds down the pendant rope 15c in the deviation prevention mechanism 82 is removed), the rope connecting member 76 becomes movable in the direction (upward direction) indicated by a broken line arrow shown in FIG. 12. If the pendant rope 15b is stretched upward in a state where the support by the fixed support member 70 is released in this manner, the rope connecting member 76 is separated from the fixed support member 70, and in conjunction with this, the pendant rope 15c is also separated from the main body of the second intermediate jib 30c.

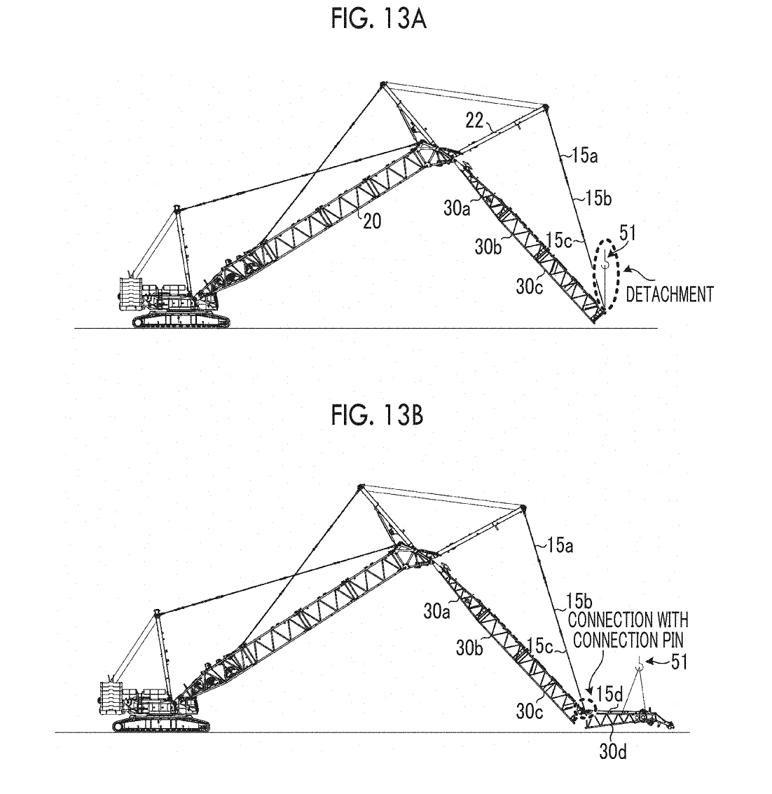

FIG. 13A shows a state where the pendant rope 15c is separated from the second intermediate jib 30c by stretching the pendant ropes 15a and 15b by raising the front strut 22. In this state, since the jibs 30a to 30c can be supported by themselves by only the tension of the pendant ropes 15a to 15c, the support by the auxiliary crane 51 can be removed. In this state, the tip of the pendant rope 15c is supported by the fixed support member 70 on the tip side of the second intermediate jib 30c. That is, the fixed support member 70 on the tip side of the second intermediate jib 30c holds the lower jib 30a, the first intermediate jib 30b, and the second intermediate jib 30c connected to the boom 20, in a state of being hung by the connected pendant ropes 15a to 15c. Then, a cure is performed for a while in a state where the jibs 30a to 30c are supported by themselves, and electric wiring or the like is performed.

After the cure, the upper jib 30d is mounted on the tip side of the second intermediate jib 30c (FIG. 13B). At the time of this mounting, the mounting may be performed in a state where the upper jib 30d is placed on the ground. Further, at this step, only the back surface sides are connected to each other with a connection pin. The auxiliary crane 51 lifts and supports the upper jib 30d.

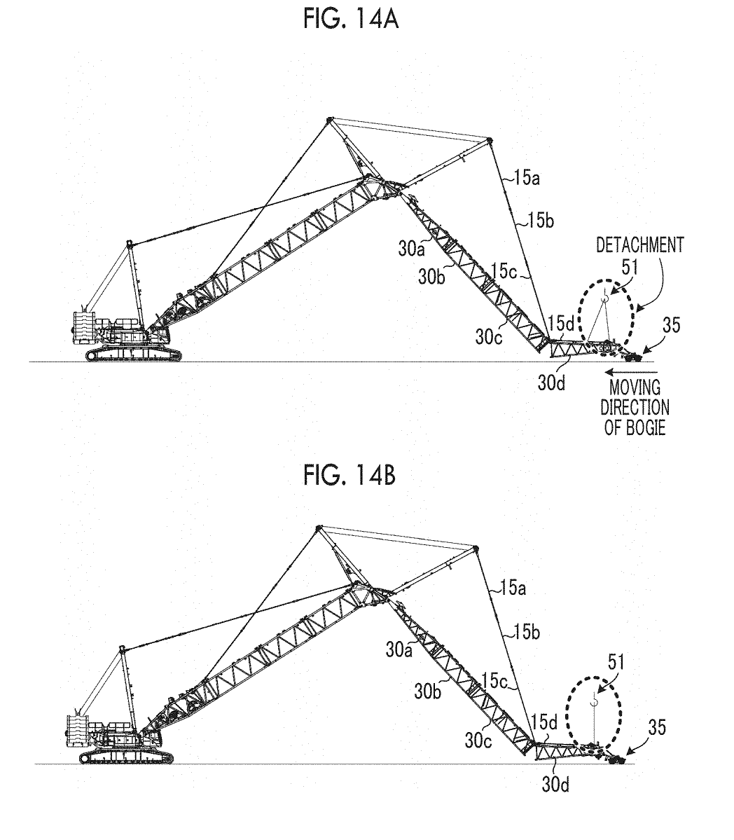

Next, as shown in FIG. 14A, a bogie 35 is disposed so as to be movable in the direction of an arrow, and the auxiliary crane 51 is operated such that the tip side of the upper jib 30d is placed on the bogie 35. Thereafter, the sling of the auxiliary crane 51 lifting a body portion of the upper jib 30d is temporarily detached, and the tip side of the upper jib 30d is lifted (FIGS. 14A and 14B).

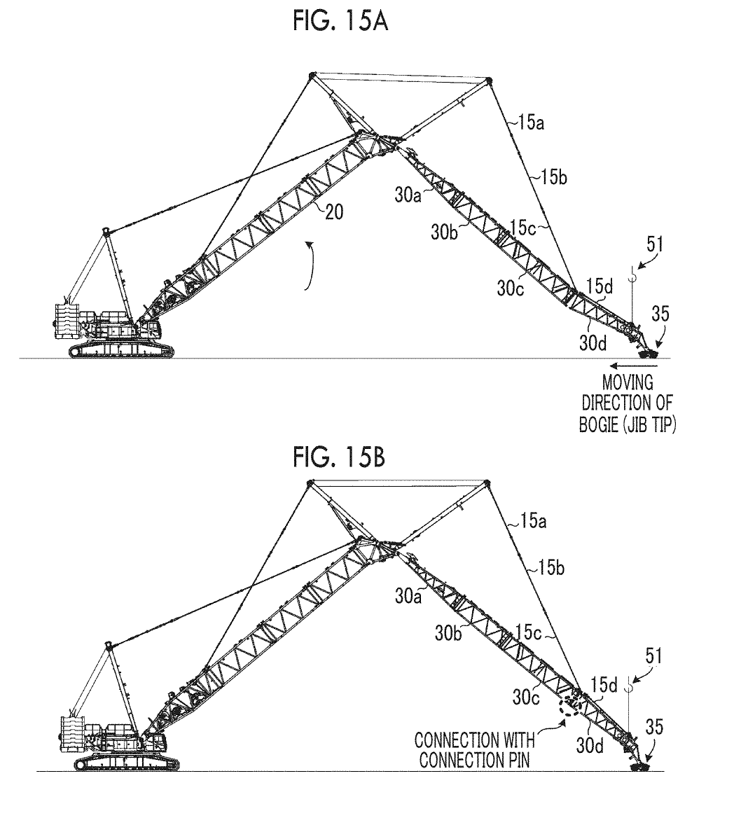

In this state, if the boom 20 is raised, the tip of the upper jib 30d placed on the bogie 35 moves in the direction of an arrow shown in FIG. 15A, and in conjunction with this, the abdominal part side of the second intermediate jib 30c and the abdominal part side of the upper jib 30d are brought close to each other (FIG. 15A). Then, the abdominal part side of the second intermediate jib 30c and the abdominal part side of the upper jib 30d are connected to each other with a connection pin (FIG. 15B). In this way, the second intermediate jib 30c and the upper jib 30d are fixed to each other, and all of the lower jib 30a, the first intermediate jib 30b, the second intermediate jib 30c, and the upper jib 30d are connected and integrated with each other.

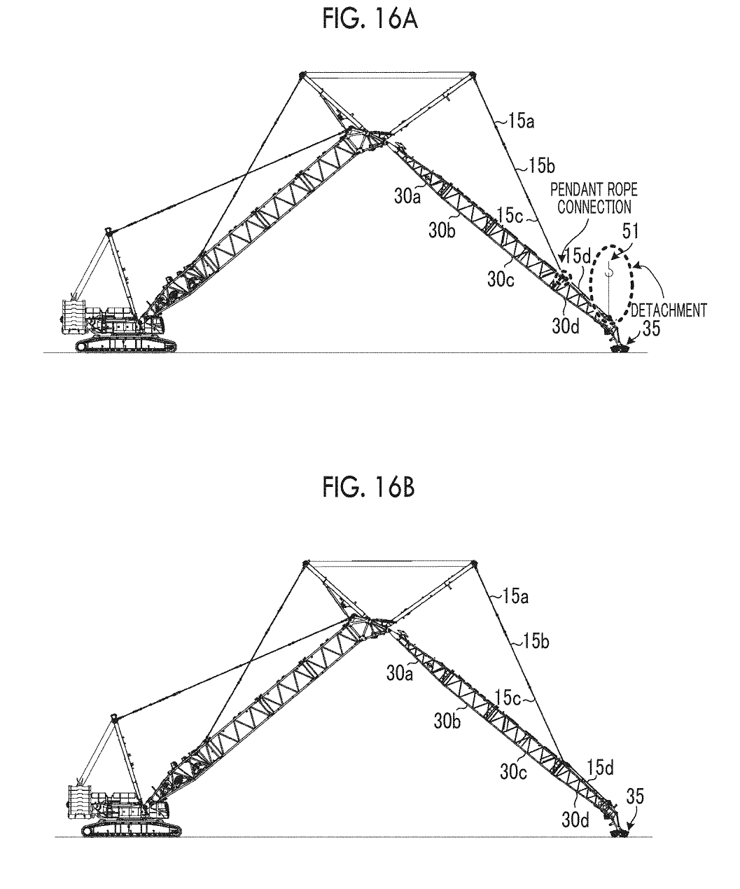

Next, the pendant rope 15c on the second intermediate jib 30c side and the pendant rope 15d on the upper jib 30d side are connected to each other through the rope connecting member 76. For this connection, it is possible to divert the method described using FIG. 11. Then, the sling of the auxiliary crane 51 is detached, and thus the hanging of the upper jib 30d by the auxiliary crane 51 is released (FIGS. 16A and 16B).

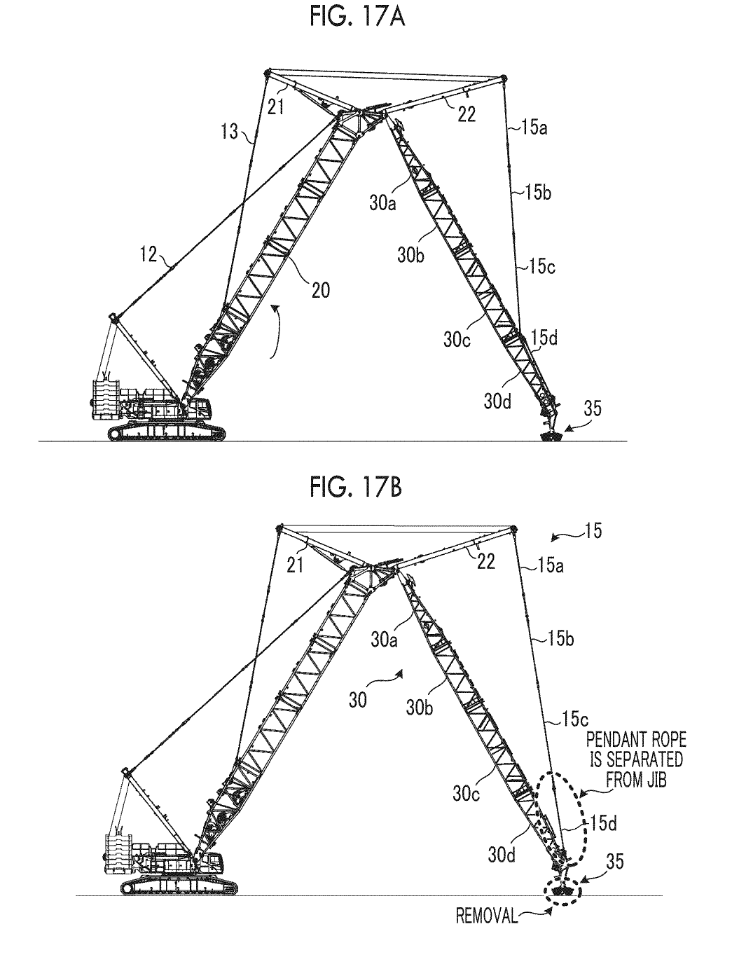

In the state shown in FIG. 16B, if the boom 20 is further raised and the front strut 22 is operated, the pendant rope 15d on the upper jib 30d side is stretched upward and separated from the main body of the upper jib 30d (FIGS. 17A and 17B). In the state shown in FIG. 17B, the entire jib 30 can be lifted by itself by the pendant ropes 15a to 15d. At this step, the bogie 35 is removed.

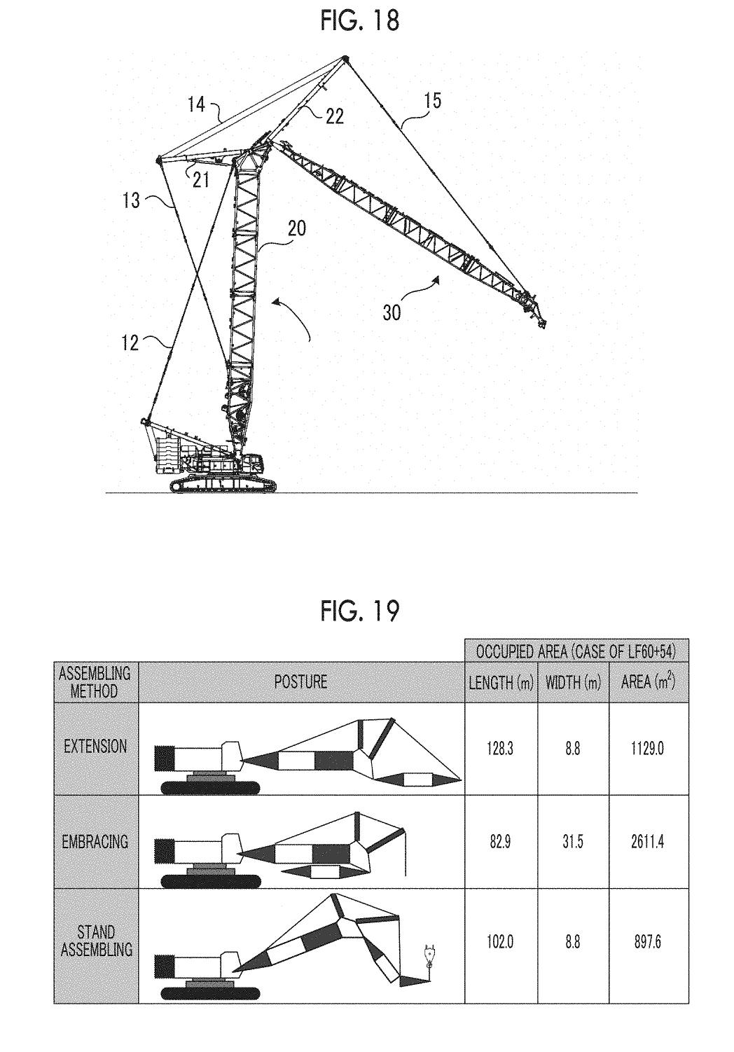

If the boom 20 is further raised from the state of FIG. 17B, the posture shown in FIG. 18 is created, and the front strut 22 is raised, whereby the posture shown in FIG. 1 is created, and thus the assembling is completed.

FIG. 19 is a diagram showing an example of comparison of an occupied length, an occupied width, and an occupied area at the time of the extension type assembling and the embracing type assembling shown in FIG. 22C, with an occupied length, an occupied width, and an occupied area in the method (stand assembling type) in this embodiment. Also in FIG. 19, similar to FIG. 22C, the length of the boom is set to be 60 m and the length of the jib is set to be 54 m. The stand assembling type of this embodiment is carried out, whereby the occupied length becomes shorter than that in the extension type, and it is approximately the middle between the occupied length in the extension type and the occupied length in the embracing type. Further, the occupied width is the same as that in the extension type. From this, the occupied area (lengthxwidth) by the stand assembling type of this embodiment becomes smaller than that in the extension type method or the embracing type method, and thus, even in a limited space within a work site, it becomes possible to perform assembling.

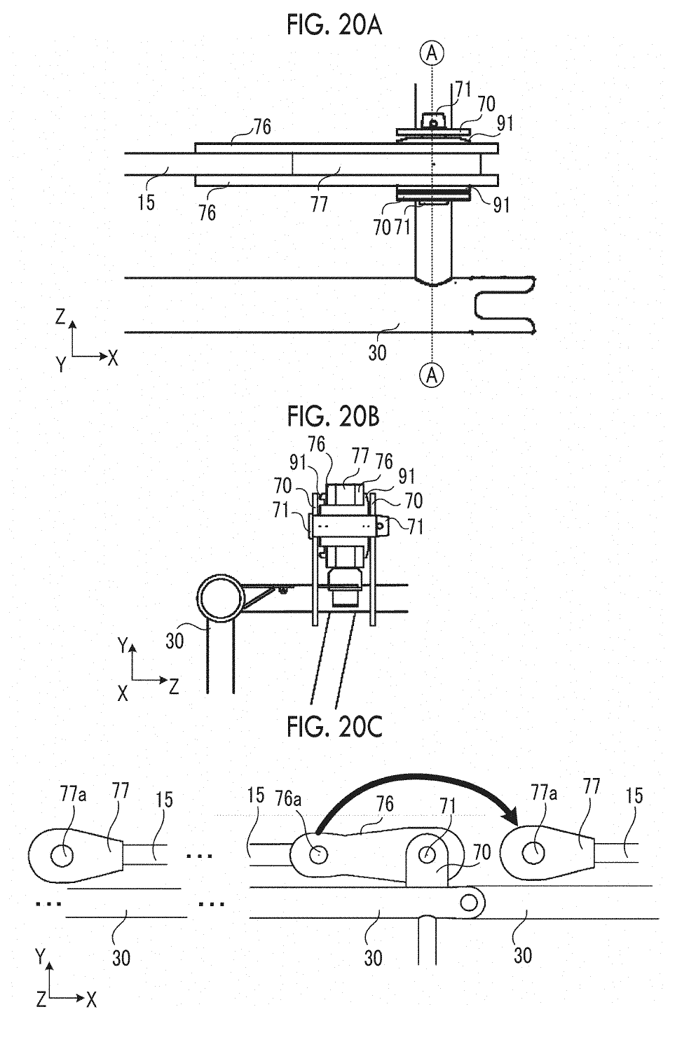

FIGS. 20A to 20C are diagrams illustrating another connection mechanism of the pendant rope 15. FIG. 20A is a top view of the vicinity of the connection mechanism of the pendant rope 15, and FIG. 20B is a sectional view taken along line A-A shown in FIG. 20A. Further, FIG. 20C is a side view and is a diagram for describing a method when connecting the pendant rope 15.

In the example shown in FIGS. 20A to 20C, the end portion 77 of the pendant rope 15 is clamped by the rope connecting member 76 and integrated with the rope connecting member 76 by using a member 91. Then, a configuration is made in which the end portion 77 and the rope connecting member 76 are further clamped by the fixed support member 70 fixed to the jib 30.

The member 91 functions as a rotating shaft for both the end portion 77 and the rope connecting member 76, as shown in FIG. 20B, and a hole portion for penetrating the lock pin 71 is formed at the center portion of the rotating shaft. A hole portion is also formed in the fixed support member 70, and the respective hole portions overlap, thereby forming a configuration in which the lock pin 71 is inserted (refer to FIG. 20B). The rope connecting member 76 and the end portion 77 of the pendant rope 15 become rotatable in the direction of an arrow in FIG. 20C with the lock pin 71 as a shaft center.

A method of connecting the pendant rope 15 by the connection mechanism will be described with reference to FIG. 20C. The configuration of the end portion 77 on one side of the pendant rope 15 is configured to be connected to the rope connecting member 76, as shown in FIGS. 20A or 20B. However, the end portion 77 on the other side is configured to have the hole portion 77a shown in FIG. 20C. When connecting the pendant rope 15, the rope connecting member 76 is rotated in the direction of the arrow shown in FIG. 20C, and thus the hole portion 76a and the hole portion 77a are overlapped. Then, a connection pin is inserted into the through-hole which is formed by the hole portions 76a and 77a. In this way, both the pendant ropes 15 are connected to each other through the rope connecting member 76. Thereafter, the lock pin 71 coupling the end portion 77 of the pendant rope 15, the rope connecting member 76, and the fixed support member 70 together is removed, whereby the pendant rope 15 can be separated from the jib 30 in a connected state.

When assembling the jib of the crane by the assembling method of this embodiment, it becomes possible to further reduce the occupied area than in the extension type or the embracing type.

Further, in the assembling method of this embodiment, when assembling the jib, since it is possible to dispose the jib such that the abdominal part side of the jib divided body faces the ground and the back surface side always faces upward, reversing work is not needed. Further, in the assembling method of this embodiment, since it is possible to perform the assembling work of the jib with only one auxiliary crane, it becomes easy to secure the space for the auxiliary crane, compared to the method of the related art, which requires two auxiliary cranes.

Further, the deviation preventionmechanism is provided in the vicinity of the end portion of the divided pendant rope, whereby it is possible to fix the vicinity of the end portion of the pendant rope to some extent. With this configuration, it is possible to easily perform alignment of the hole portion of the rope connecting member with the hole portion of the end portion of the pendant rope.

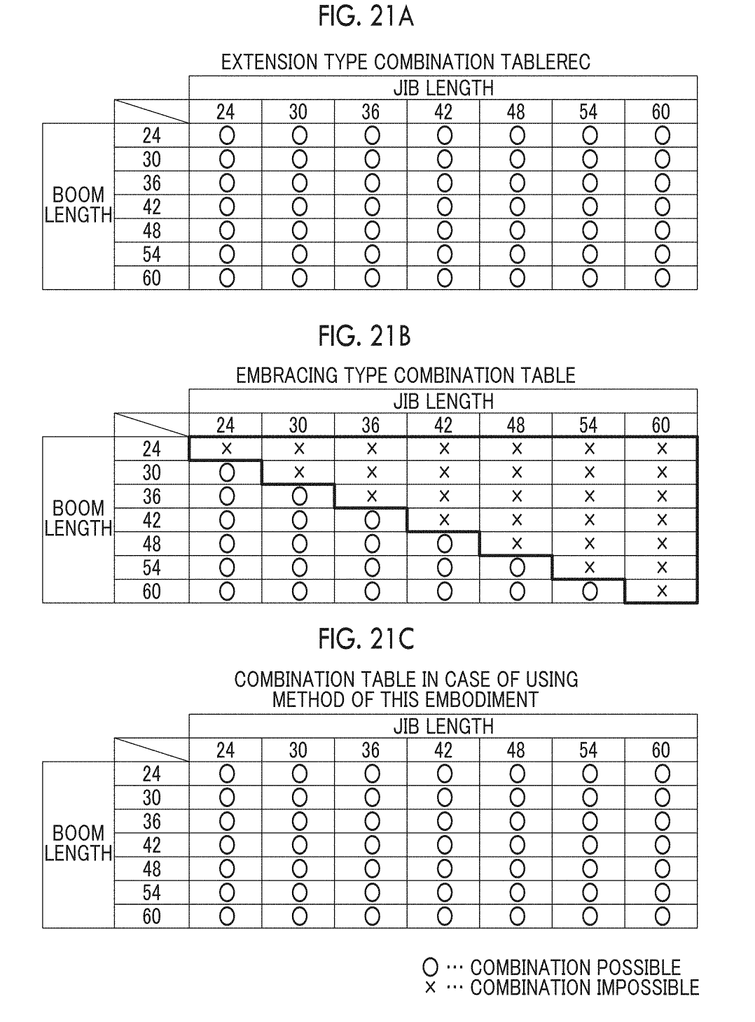

Finally, the possibility of assembling in cases of applying the extension type and the embracing type which are the assembling methods of the related art, and the method of this embodiment will be described with reference to FIGS. 21A to 21C. FIG. 21A shows a combination table in the extension type, and FIG. 21B shows a combination table in the embracing type. Further, FIG. 21C shows a combination table in a case of applying the method of this embodiment. In each table, a boom length is shown in the vertical direction and a jib length is shown in the horizontal direction, and whether or not assembling is possible is indicated in each section.

In the case of the extension type, there is no restriction on the assembly due to the boom length and the jib length. On the other hand, in the case of the embracing type, for convenience of the assembling method, in a combination where the length of the jib is equal to or greater than the length of the boom, assembling is not possible or becomes difficult.

In this manner, in the embracing type, as shown in FIG. 21B, there are cases where a combination is not possible due to the relationship between the length of the jib and the length of the boom. However, in the assembling method of this embodiment, the restriction disappears. That is, in the stand assembling method of this embodiment, as shown in FIG. 21C, the same combinations as those in the extension type become possible.

As described in detail above, according to this embodiment, it is possible to provide a technique that reduces the occupied area when assembling the jib and facilitates the jib assembling work.

It should be understood that the invention is not limited to the above-described embodiment, but may be modified into various forms on the basis of the spirit of the invention. Additionally, the modifications are included in the scope of the invention.

What is claimed is:

1. A crane which performs a hanging operation by connecting a jib to a boom, the crane comprising:
a plurality of jib divided bodies into which the jib is divided;
a plurality of support rope divided bodies into which a support rope supporting the jib is divided, and which are respectively installed on the jib divided bodies in a step before assembling;
a connection body which connects the support rope divided bodies to each other; and
a fixed support member which detachably supports the support rope divided body and the connection body on the jib divided body,
wherein the fixed support member can hold the jib divided body connected to the boom, in a state of being hung by the connected support rope divided body.

2. The crane according to claim 1,
wherein at least one of the support rope divided body and the connection body has a rotating shaft, and the fixed support member supports the rotating shaft.

3. The crane according to claim 2,
wherein the fixed support member clamps the connection body on both sides and supports the rotating shaft.

4. The crane according to claim 2, further comprising:
a restricting member which restricts rotation of the connection body.

5. The crane according to claim 1,
wherein the fixed support member supports a pin penetrating an end portion of the support rope divided body and the connection body.

6. The crane according to claim 1,
wherein the jib divided body has a suppressing member which suppresses a deviation of the support rope divided body.

7. A method of assembling a jib of a crane that performs a hanging operation by connecting the jib to a boom, the crane including
a plurality of jib divided bodies into which the jib is divided,
a plurality of support rope divided bodies into which a support rope supporting the jib is divided, and which are respectively installed on the jib divided bodies in a step before assembling,
a connection body which connects the support rope divided bodies to each other, and
a fixed support member which detachably supports the support rope divided body and the connection body on the jib divided body,
the method comprising:
making the connected jib divided body connected to the boom at one end be in a state of being lifted by the connected support rope divided body which has been connected;
connecting the jib divided body to be connected subsequently and the connected jib divided body to each other in the lifted state;
connecting the support rope divided body to be connected subsequently, which is disposed on the jib divided body to be connected, and the connected support rope divided body to each other by the connection body; and
releasing the support of the connected jib divided body by the fixed support member.

8. The method of assembling a jib according to claim 7,
wherein a back surface side of the connected jib divided body and a back surface side of the jib divided body to be connected are connected to each other in the lifted state, and
after the abdominal part sides of the connected jib divided body and the jib divided body to be connected are connected to each other with the connected jib divided body and the jib divided body to be connected aligned in a straight line by lifting the boom, the connected support rope divided body and the support rope divided body to be connected are connected to each other by the connection body.
